(19) United States
(12) Patent Application Publication
(10) Pub. No.: US 2010/0046781 A1
(43) Pub. Date: Feb. 25, 2010

(54) Headphone with storage compartment

(76) Inventor: Jinsuan Chen, Chung Ho City (TW)

Correspondence Address: HOFFMAN, WASSON & GITLER, P.C., Suite 522, 2461 South Clark Street, Arlington, VA, 22202, US

(21) Appl. No.: 12/230,139

(22) Filed: Aug. 25, 2008

(51) Int. Cl. H04R 25/00

(52) U.S. Cl. 381/371

(57) ABSTRACT

A headphone provided with an ear cup into which a storage compartment is to be inserted. The storage compartment includes a cavity for the storage of a dongle when the headphone is not in use. Since the purpose of the dongle is to establish a wireless communication between an audio device and the headphones, the dongle is removed from the storage compartment and plugged into the audio device to facilitate the wireless communication. After the wireless communication terminates, the dongle is re-inserted into the storage compartment.

### FIELD OF THE INVENTION

The present invention is directed to headphones designed to receive wireless communication.

### BACKGROUND OF THE INVENTION

It is well known that wireless technology is being widely utilized for the purpose of communication between a multitude of devices. These devices could be separated by a relatively large distance or could be in close proximity with one another. If the distances between the devices are short, a wireless transmission technique such as Bluetooth would enable a wireless connection between the transmitting device and the receiving device. This technology transmits data and audio signals generally utilizing a frequency in the ISN band. This technology can be applied to audio appliances such as MP3 players, computers as well as various types of audio home entertainment systems. The wireless system would normally consist of one transmitting device and one receiving device provided in two different housings. The transmitting device may take the form of a portable dongle that would be connected to the audio source for wirelessly transmitting the audio signal from the transmitting device to the receiving device. The receiving device could take the form of monaural or stereo headphones, each having two ear pieces or ear cups. The headphones would include a receiver to receive audio signals sent from the transmitting device with the assistance of the dongle. Unfortunately, if the dongle is misplaced or becomes broken, the receiving device, such as the headphones cannot properly function.

### SUMMARY OF THE INVENTION

The present invention overcomes the deficiencies of the prior art by providing a headphone having two ear cups. At least one of the ear cups is provided with an external opening to house a storage compartment removably or preferably permanently provided therein with the device to facilitate the audio transmission from the transmitting device to be received by the headphone. Therefore, when not in use, the dongle would be housed within the storage compartment which is in turn included in one of the ear cups of the headphone, thereby making it less likely that the dongle would be lost, misplaced or damaged.

Consequently, it is an object of the present invention to provide a headphone for a wireless portable transmitting device, such as a dongle, which is removably mounted within a storage compartment housed in one of the ear cups of the headphone. When it is desired to provide a wireless audio transmission to the headphones, the dongle is retrieved from the storage compartment. After the wireless transmission has been completed, the dongle would be re-inserted into the storage compartment.

These and other objects of the present invention will be better appreciated and understood when considered in conjunction with the following description and accompanying drawings. It should be understood, however, that the following description, while indicating a preferred embodiment of the invention is given by way of illustration and not of limitation. Many changes and modifications may be made within the scope of the embodiment of the invention without departing from the spirit thereof and the invention would include all such modifications.

### BRIEF DESCRIPTION OF THE DRAWINGS

FIG. 1 is a front view of the headphones of the present invention showing the storage compartment in phantom;

FIG. 2 is a drawing of the dongle used in the present invention; and

FIG. 3 is a perspective view of the storage compartment with the dongle as well as the cover of a battery compartment removed.

### DETAILED DESCRIPTION OF THE PRESENT INVENTION

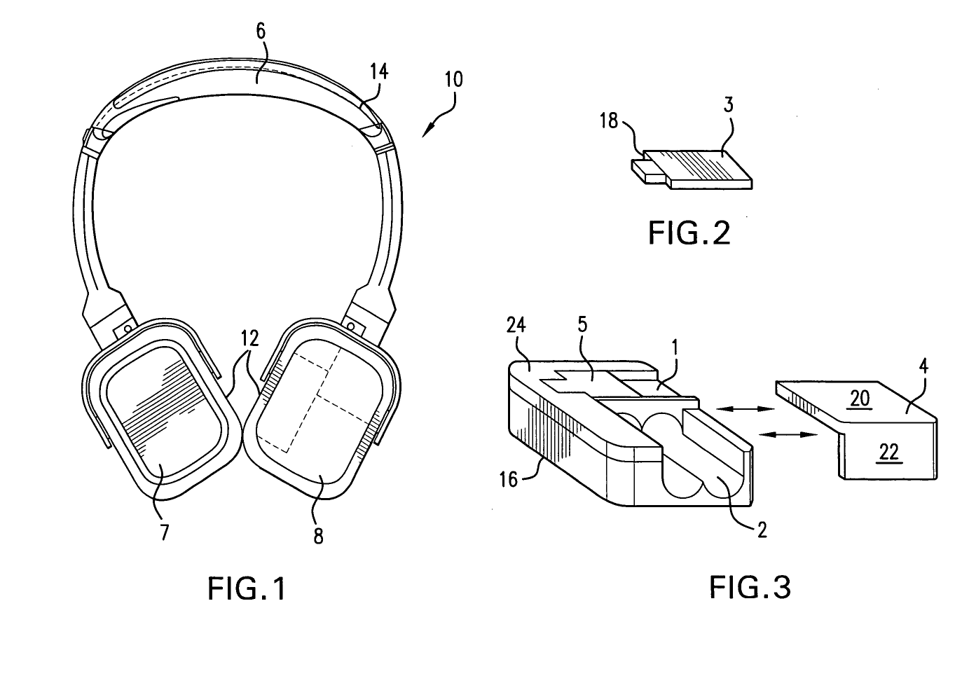

As illustrated in FIG. 1, a headphone 10 is provided including a first ear cup 7 and a second ear cup 8. A headband 6 interconnects the ear cups 7 and 8 to one another. Each of the ear cups include a periphery 12 surrounding the outside of the respective ear cup. The headband 6 provided with a device 14 for changing the effective length of the headband 6 to accommodate different users. This device 14 is standard in the art, and does not need additional explanation.

The headphone 10 of the present invention is designed to be utilized in a wireless communication system. Therefore, a receiver adapted to receive wireless communications is provided within the headphone structure, such as, but not limited to ear cups. Each of the ear cups 7 and 8 is provided with a separate speaker in communication with the receiver for enabling the user to hear the audio material transmitted wirelessly from any device capable of transmitting audio material facilitated by a device such as a dongle 3 as illustrated in FIG. 2. Each of the speakers is preferably located at the bottom of its respective ear cup. The dongle includes a plug 18 plugged into a port in the appropriate audio transmission device. Any standard plug such as a 2.5 mm or 3.5 mm can be utilized as well as any type of USB port which would be used particularly if the Bluetooth technology is employed.

As previously described, the dongle 3 is used to convert the audio material produced by any audio devices into a wireless signal such as to be transmitted utilizing an RF frequency or an IR frequency. The produced wireless transmission could then be received by the receiver provided within the headphones 10. As can be appreciated, if the dongle 3 is lost or broken, no wireless signal can be transmitted from the particular audio device to the receiver. The present invention prevents the loss or breakage of the dongle 3 by including a separate storage compartment 16 which is removably or preferably permanently provided in the interior of ear cup 8, as shown in FIG. 1.

The storage compartment 16 as well as the dongle 3 can be constructed from a plastic or metal material. The storage container 16 is provided with a cover 24 provided on a portion of the top surface of the storage compartment 16, covering a cavity 5. The cover 24 is not provided over a portion of a slot 1 which allows access to the interior of cavity 5. The dongle 3 is inserted through the slot 1 and into the cavity 5 such that the dongle 3 is not only secured within the cavity 5 but a portion of the dongle 3 would remain uncovered within the slot 1, allowing the dongle to be removed from the cavity 5 when it is desired to provide wireless communication between an audio device and the headphones 10.

The storage compartment 16 includes a compartment 2 into which one or more batteries are to be inserted. These batteries are connected to the receiver provided within the ear cup by a wire (not shown), and are used to power the receiver. A cover 4, provided with a top surface 20 and a side surface 22, is removably attached to the storage compartment 16 allowing the batteries to be secured therein when cover 4 is applied to the top of the battery compartment 2. The cover 4 is removable from the top and side of the battery compartment 2 for the purpose of replacing and changing the batteries.

The storage compartment 16 is adapted to be removably or preferably permanently provided in the ear cup 8. The storage compartment 16 is secured in the ear cup 8 through the use of any type of attachment device such as a friction fit between the exterior surface of the storage compartment 16 and the interior side surface of the ear cup 8. Alternatively, a recess could be provided within the ear cup 8 into which the storage compartment 16 would fit.

When the headphones 10 are not in use, the storage compartment 16 would be included within the ear cup 8 and the dongle 3 would be secured within the cavity 5, as shown in FIG. 1. When a wireless communication is to be established between the receiver provided within the headphones 10 and the audio device, the dongle 3 is removed from the cavity 5 while the storage compartment remains in the interior of the ear cup 8. The dongle 3 is then inserted into a plug in the particular audio device and a wireless communication is established between the audio device and the receiver in the head set in the dongle 3. When the wireless communication is terminated, the dongle 3 is removed from the appropriate audio device and is re-inserted through slot 1 into the cavity 5, while the storage compartment remains in the ear cup 8. Similarly cover 4 can be removed while the storage compartment 16 remains in the ear cup, allowing the batteries to be changed.

The foregoing description of the specific embodiment of the present invention will reveal the general nature of the invention that others can, by applying current knowledge, readily modify or adapt for various applications, such specific embodiments without departing from the generic concept, and therefore, such adaptations and modifications should and are intended to be within the meaning and range of equivalence of the disclosed embodiment. It is to be understood that the phraseology or terminology employed herein is for the purpose of description and not of limitation. Therefore, while the invention has been described in terms of a preferred embodiment, those skilled in the art will recognize that the invention can be practiced with modification within the spirit and scope of the invention.

What is claimed is:

1. A pair of headphones, comprising:
first and second ear cups;
a headband provided between and connected to said first and second ear cups;
a storage compartment provided within said first ear cup, said storage compartment provided with a cavity for storing a wireless transmission facilitator therein;
a receiver provided within said second ear cup for receiving a wireless communication; and
a speaker provided in each of said ear cups for and in communication with said receiver for playing an audio signal.

2. The pair of headphones in accordance with claim 1, wherein said storage compartment is included with a permanent cover provided over said cavity, and a slot in communication with said cavity provided outside of said permanent cover.

3. The pair of headphones in accordance with claim 2, wherein said wireless transmission facilitator is a dongle.

4. The pair of headphones in accordance with claim 2, wherein said storage compartment is provided with a battery storage compartment and a cover, removably covering said battery compartment.

5. The pair of headphones in accordance with claim 1, wherein said storage compartment is permanently provided within said first ear cup, wherein said wireless transmission facilitator is removed from as well as inserted into said cavity without removing said storage compartment from said first ear cup.

6. The pair of headphones in accordance with claim 4, wherein said storage compartment is permanently provided within said first ear cup, wherein said wireless transmission facilitator is removed from as well as inserted into said cavity without removing said storage compartment from said first ear cup.
